(19) United States
(12) Patent Application Publication
(10) Pub. No.: US 2007/0144972 A1
(43) Pub. Date: Jun. 28, 2007

(54) Monolithic Organic Copolymer for Biopolymer Chromatography

(75) Inventors: Gunther Bonn, Zirl (AT); Said Lubban, Gaza (IL); Lukas Trojer, Ampass (AT)

Correspondence Address: BIRCH STEWART KOLASCH & BIRCH, PO BOX 747, FALLS CHURCH, VA, 22040-0747, US

(73) Assignee: Leopold-Franzens-Universitat Innsbruck, Innsbruck (AT)

(21) Appl. No.: 11/419,461

(22) Filed: May 19, 2006

Related U.S. Application Data
(63) Continuation-in-part of application No. 11/316,970, filed on Dec. 27, 2005.

(51) Int. Cl. B01D 15/08

(52) U.S. Cl. 210/656; 525/50

(57) ABSTRACT

Monolithic organic copolymer prepared by copolymerisation of an alkylstyrene and a divinylbenzene or a derivative thereof in the presence of a porogen, wherein said porogen comprises decanol and at least one of the group consisting of tetrahydrofuran and toluene.

### BACKGROUND OF THE INVENTION

This application is a Continuation-In-Part of co-pending application Ser. No. 11/316,970 filed on Dec. 27, 2005, the entire contents of which are hereby incorporated by reference and for which priority is claimed under 35 U.S.C. § 120.

### FIELD OF THE INVENTION

The present invention is directed to a monolithic organic copolymer prepared by copolymerisation of an alkylstyrene and a member out of the group consisting of a bis(vinylphenyl)alkane and a bis(vinylphenylalkyl)benzene in the presence of a porogen. The present invention is directed further to a method for separating biopolymers using high performance liquid chromatography, wherein as stationary phase this monolithic organic polymer is used.

### DISCUSSION OF THE BACKGROUND

Monolithic stationary phases for high performance liquid chromatography (HPLC) were originally called ‘continuous rods’. This term already indicates one of the characteristics of monoliths: they are a single polymer-piece built within the confine of HPLC column housings or fused silica capillaries.

Monolithic phases exhibit a bimodal pore-size distribution (macro- and mesopores). Macropores in the μm-range are necessary to get a solvent flow through the polymer, whereas the presence and distribution of mesopores controls the chromatographic efficiency of the support material towards biomolecules [1-4]. The development of the unique macroporous monolithic structure is generally ascribed to the presence of inert diluents (porogens) during the polymerisation process [5]. The fabrication of organic macroporous polymers (division of monolithic materials see next paragraph) is mostly done in the presence of a binary solvent mixture—composed of micro- and macroporogen—which is responsible for the distribution of the overall porosity [6].

During the last 10 years, much attention has been paid to the development of monolithic phases of different chemistry and their chromatographic application. Generally, monolithic materials are divided into two fields:

(1) Monoliths built up by copolymerisation of organic monomers—thermally initiated free radical polymerisation of styrenes [4, 7-9] and acrylates [10,11] and further photochemically initiated free radical polymerisation of UV-transparent acrylates [12] were successfully utilised to develop rigid, mechanically stable polymers. Furthermore, monolithic separation media were produced by ring opening metathesis polymerisation (ROMP) [13]; and

(2) Monoliths built up by polymerisation of inorganic monomers—silica based monolithic skeletons were fabricated employing the sol-gel process using silane-precursors [14,15].

Concerning the field of biopolymer chromatography, which term covers the separation of biopolymers such as proteins, peptides, oligonucleotides as well as dsDNA-fragments, monolithic reversed phase (RP) materials based on Polystyrene/Divinylbenzene (PS/DVB) were shown to be best suited to achieve high resolution separations [9,16]. A PS/DVB monolith was finally commercialised by LC-Packings, a Dionex company (The Netherlands).

Hydrophobic organic polymers such as PS/DVB or polymers made by ROMP are known to suffer from swelling problems in organic solvents (especially in good polymer solvents like THF, CH₂Cl₂ and toluene) [17].

Monolithic PS/DVB polymers are further restricted to derivatisation reactions based on Friedl-Crafts alkylation [18].

In the prior art, monolithic capillary columns prepared by copolymerisation of styrene and divinylbenzene (PS/DVB) are known to be best suited for biopolymer chromatography regarding peak sharpness and resolution [9, 16]. These columns have been commercialised by LC-Packings, a Dionex company (The Netherlands). These columns however suffer from disadvantages as it has been described above. In addition, the commercialised PS/DVB (LC-Packings) monolith is severely restricted in permeability, leading to long separation and moreover long column equilibration times, which is an essential limitation in biopolymer chromatography, where solvent gradients are routinely used to elute sample components.

### SUMMARY OF THE INVENTION

Accordingly, it is one object of the invention to overcome the problem mentioned above and to provide a respective monolithic organic copolymer which can be used advantageosly in biopolymer chromatography.

This and further objects, which will become apparent from the following specification have been achieved by a novel monolithic organic copolymer prepared by copolymerisation of an (C₁-C₃)alkylstyrene and a member out of the group consisting of bis(vinylphenyl)(C₁-C₄)alkane and bis(vinylphenyl(C₁-C₂)alkyl)benzene in the presence of a porogen, wherein said porogen comprises decanol and at least one of the group consisting of tetrahydrofuran and toluene.

The moderate hydrodynamic properties of the PS/DVB monolith are pointed up by FIG. 3, where the permeability of the commercially available PS/DVB capillary column (Dionex PS/DVB, 50×0.2 mm) is compared to the MS/BVPE monolith (MS/BVPE, 80×0.2 mm) according to the invention.

A preferred embodiment of the monolithic organic copolymer can be prepared by using a porogen which is a mixture of decanol and toluene or a mixture of decanol and tetrahydrofuran.

It has been shown that tetrahydrofuran is contained in the porogen within the preferred range of 12-16 vol.-% (based on the total volume of the porogen mixture). It has also been shown that toluene is contained in the porogen within the preferred range of 16-40 vol.-% (based on the total volume of the porogen mixture).

Said (C₁-C₃)alkylstyrene can be one of the group of mono-, di, and trialkylstyrene, e.g. m-methylstyrene, o-methylstyrene and p-methylstyrene. p-Methylstyrene is preferred.

Bis(vinylphenyl)(C₁-C₄)alkane and bis(vinylphenyl(C₁-C₂)alkyl)benzene are crosslinkers.

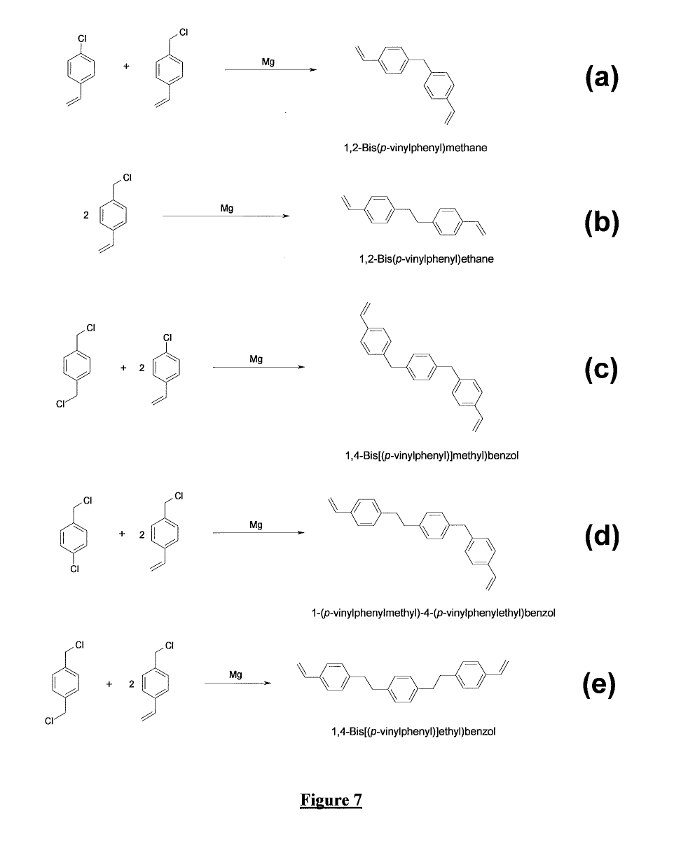

Bis(vinylphenyl)(C₁-C₄)alkanes can be prepared by Grignard reaction. Preferred embodiments are shown in FIGS. 7a and 7b.

Examples of a bis(vinylphenyl(C₁-C₂)alkyl)benzene are shown in FIGS. 7c-e.

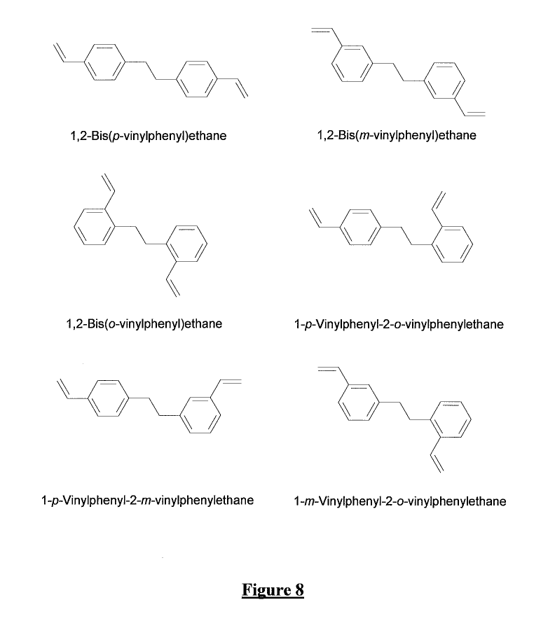

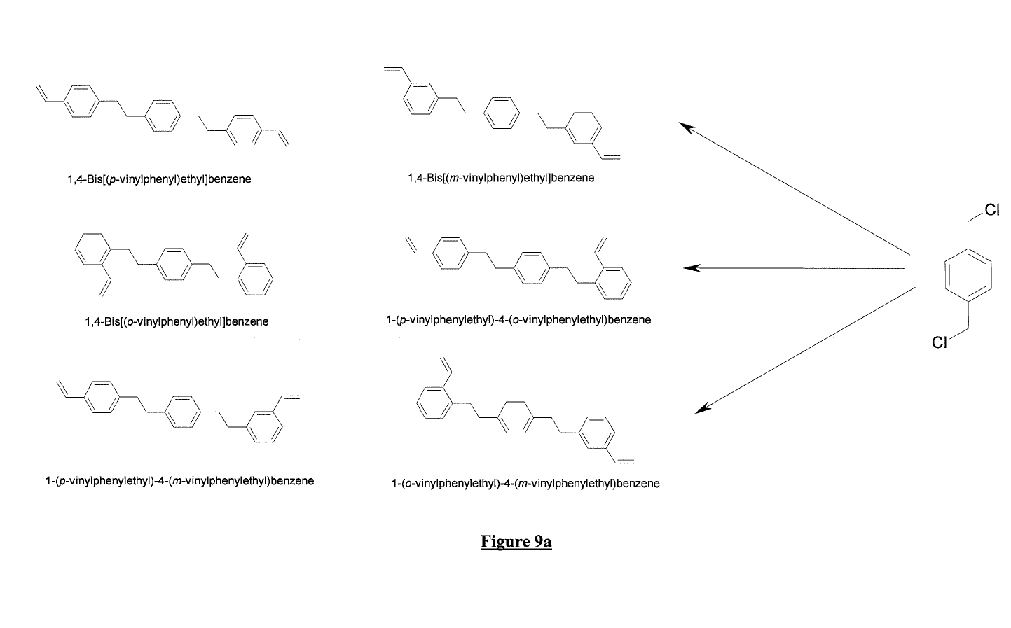

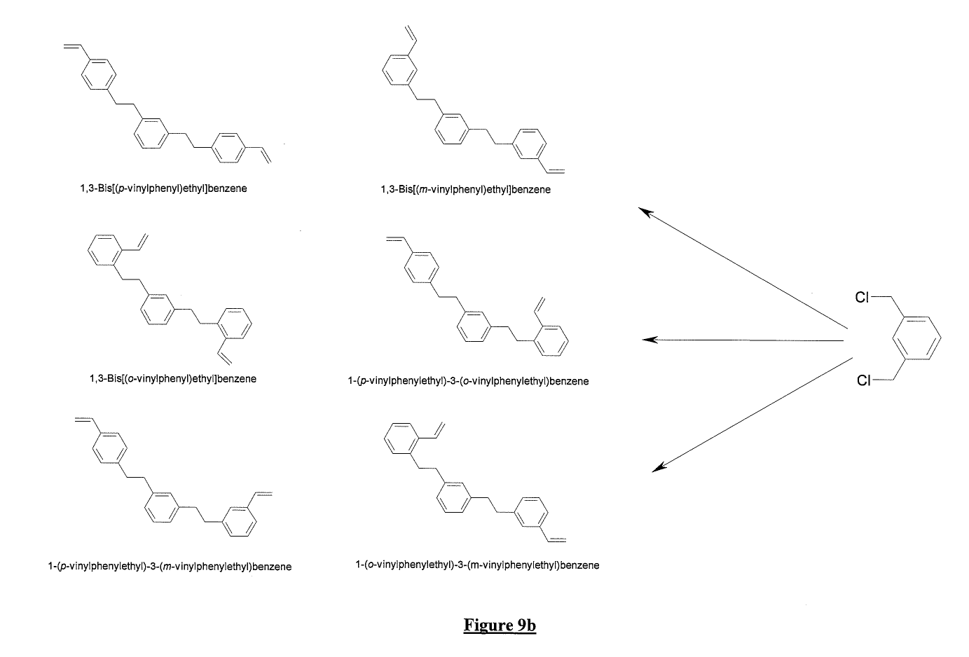

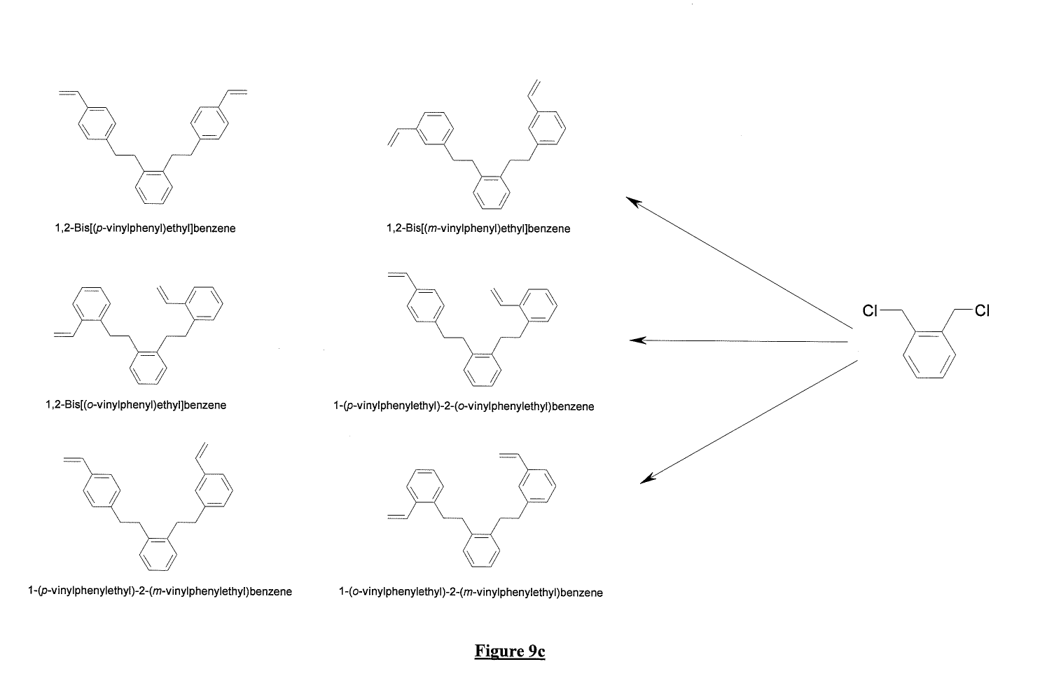

All isomers of said bis(vinylphenyl)alkane and bis(vinylphenylalkyl)benzene can be employed. Isomers of 1,2-bis(vinylphenyl)ethan (BVPE) are: 1,2-bis(p-vinylphenyl)ethan, 1,2-bis(m-vinylphenyl)ethan, 1,2-bis(o-vinylphenyl)ethan, 1-p-vinylphenyl-2-o-vinylphenylethan, 1-p-vinylphenyl-2-m-vinylphenylethan, 1-m-vinylphenyl-2-o-vinylphenylethan (FIG. 8). Isomers of bis[(vinylphenyl)ethyl]benzene are 1,4-bis[(p-vinylphenyl)ethyl]benzene, 1,4-bis[(m-vinylphenyl)ethyl]benzene, 1,4-bis[(o-vinylphenyl)ethyl]benzene, 1-(p-vinylphenylethyl)-4-(o-vinylphenylethyl)benzene, 1-(p-vinylphenylethyl)-4-(m-vinylphenylethyl)benzene, 1-(o-vinylphenylethyl)-4-(m-vinylphenylethyl)benzene, prepared via Grignard reaction of p-vinylbenzylchloride and α,α′-dichloro-p-xylene, 1,3-bis[(p-vinylphenyl)ethyl]benzene, 1,3-bis[(m-vinylphenyl)ethyl]benzene, 1,3-bis[(o-vinylphenyl)ethyl]benzene, 1-(p-vinylphenylethyl)-3-(o-vinylphenylethyl)benzene, 1-p-vinylphenylethyl)-3-(m-vinylphenylethyl)benzene, 1-(o-vinylphenylethyl)-3-(m-vinylphenylethyl)benzene, prepared via Grignard-reaction of p-vinylbeinzylchloride and α,α′-Dichloro-m-xylene, and 1,2-bis[(p-vinylphenyl)ethyl]benzene, 1,2-bis[(m-vinylphenyl)ethyl]benzene, 1,2-bis[(o-vinylphenyl)ethyl]benzene, 1-(p-vinylphenylethyl)-2-(o-vinylphenylethyl)benzene, 1-(p-vinylphenylethyl)-2-(m-vinylphenylethyl)benzene, 1-(o-vinylphenylethyl)-2-(m-vinylphenylethyl)benzene, prepared by Grignard-reaction of p-vinylbenzylchloride and α,α′-dichloro-o-xylene (FIG. 9a-c).

A preferred bis(vinylphenyl)(C₁-C₄)alkane is 1,2-bis(p-vinylphenyl)ethane (p-BVPE).

A further preferred monolithic organic copolymer, wherein said copolymerisation is carried out in a mixture containing said porogen, said alkylstyrene and said divinylbenzene derivative, is characterized in that said porogen, when being a mixture of decanol and tetrahydrofuran, is in the range of 60-65 vol.-% (of total volume of the mixture), and when being a mixture of decanol and toluene, is in the range of 59-80 vol.-% (of total volume of the mixture), with the rest being alkylstyrene and divinylbenzene.

The invention is further directed to a method for separating biopolymers using high performance liquid chromatography, characterised in that as stationary phase a monolithic organic polymer as mentioned above.

### DETAILED DESCRIPTION OF PREFERRED EMBODIMENTS

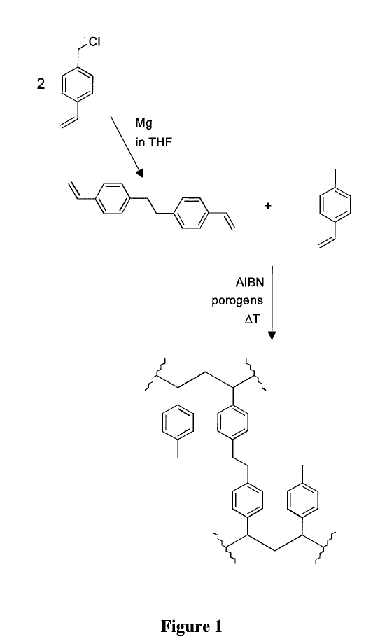

Preferred (reversed phase) monolithic materials can be prepared by α,α′-azoisobutyronitrile (AIBN) initiated, free radical copolymerisation of methylstyrene (MS) and 1,2-bis(p-vinylphenly)ethane (BVPE) according to the scheme shown in FIG. 1. The synthesis of BVPE in high yield is described by Li et al. in high yield and purify [19].

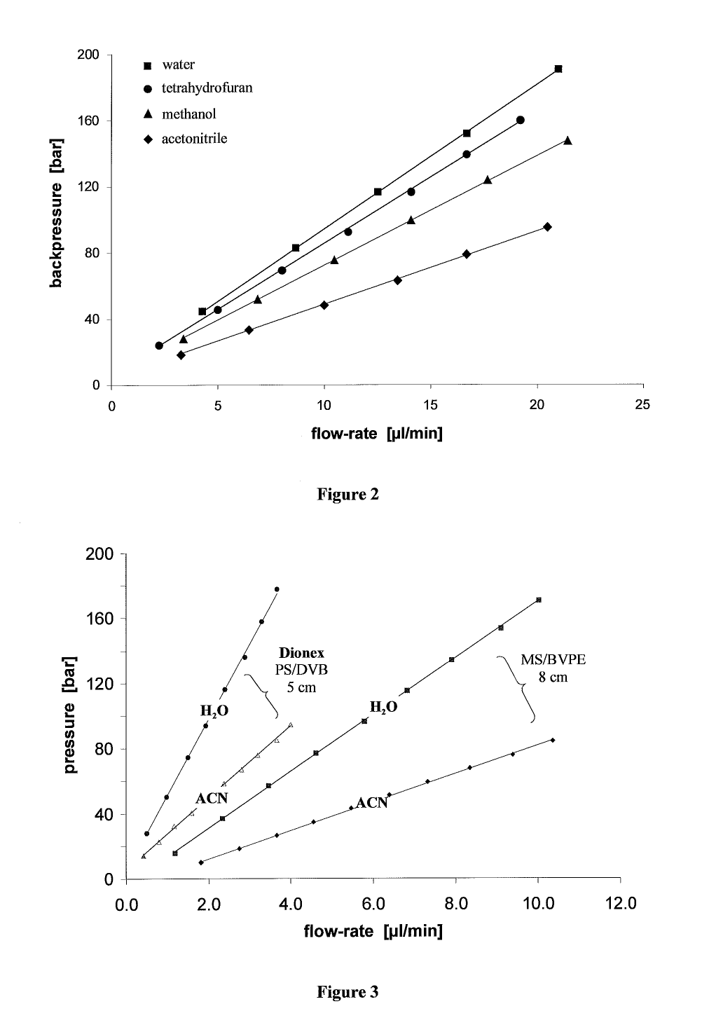

The monolithic MS/BVPE shows excellent mechanical stability and advanced swelling properties in organic solvents, as shown in FIG. 2, where the relationship between applied pressure and resulting flow-rate of a typical monolithic MS/BVPE capillary column (80×0.2 mm) was determined for 4 solvents of different polarity at room temperature. The measuring points show high linearity (R²>0.9997 for all cases), which indicates high mechanical stability of the monolithic rod. Furthermore it can be seen, that the solvents cause column backpressure according their dynamic viscosity (Darcy's law), except tetrahydrofuran, which cause slight polymer swelling. Nevertheless the swelling in tetrahydrofuran is low, as the swelling propensity (SP) [17] is 0.7, employing a molar MS to BVPE ratio of 2:1 only.

In comparison to styrene, methylstyrene possesses a methyl-group in the para-position. The presence of this group might open an additional opportunity for monolith derivation going beyond Friedl-Crafs alkylation reactions. Side chain oxidation by appropriate oxidants might result in carboxylic acid functionalities on the surface. These reactive groups then open a big variety for further derivatisation possibilities.

By variation of the total monomer to porogen ratio, further the microporogen to macroporogen content, temperature and initiator content [5, 20-22], one can strongly influence the overall porosity and thus the permeability of the macroporous MS/BVPE materials. As further discussed blow, the monolithic MS/BVPE polymer manages to combine both—having high column permeability on the one hand, while maintaining the ability of performing excellent high resolution separation of a wide spectrum of biopolymers on the other hand.

The novel MS/BVPE monolithic polymer material, which is fabricated by copolymerisation of methylstyrene and 1,2-bis-(p-vinylphenyl)ethane results macroporous polymers of high mechanical stability, which combine (1) high permeability with (2) excellent separation performance.

(1) As it is seen in FIG. 3, the commercially available PS/DVB monolith is restricted to the application of a volumetric flow-rate of approximately 4 μl/min, using 100% water as solvent, whereas the MS/BVPE monolith enables the application of a flow rate 2.5 fold higher reaching the same backpressure. Taking into account, that the column length of the novel MS/BVPE monolith is raised by 40% (5.0 to 8.0 cm), the column permeability is exceptionally high. This enables strong reduction in column equilibration times between gradient runs and moreover allows the application of steep gradients to achieve fast separations.

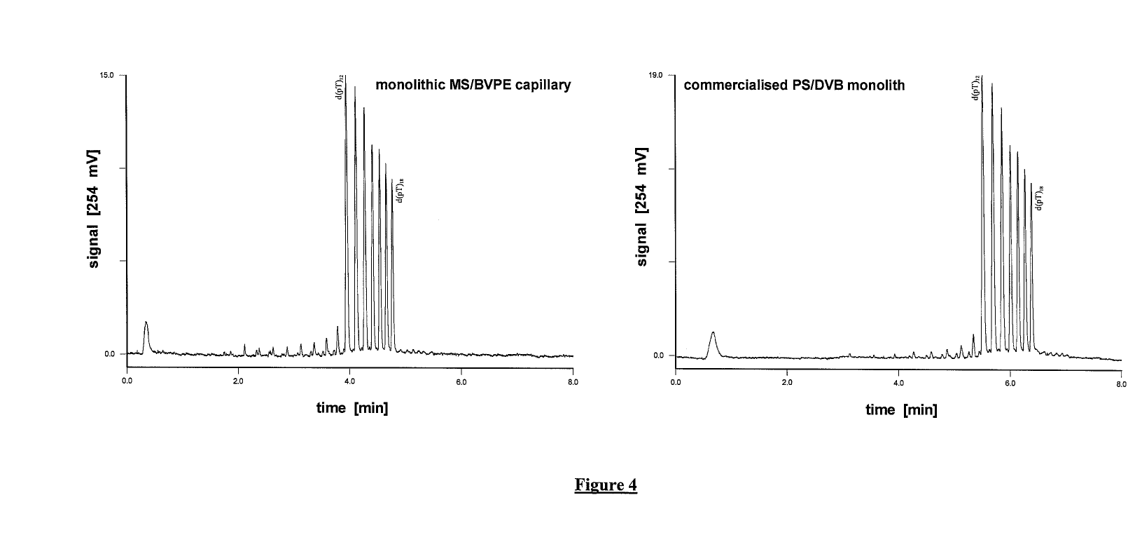

(2) The novel MS/BVPE monolithic capillary columns show separation efficiency towards a wide spectrum of biomolecules comparable to the commercially available PS/DVB monolith. This is demonstrated in FIG. 4, 5 and 6, where the separation of oligonucleotides, peptides and proteins performed on both columns under same chromatographic conditions is presented for comparison. Further information of the separation parameters of those chromatograms are summarised in Table 1. FIG. 4 gives the separation of an oligodeoxynucleotide standard d(pT)₁₂₋₁₈ using ion-pair reversed phase (IP-RP) conditions (solvent A: 0.1 M TEAA, pH 7, solvent B: 0.1 M TEAA in 40% ACN, pH 7, 2-step gradient: 0-20% B in 1 min and 20-40% B in 7 min, 50° C., UV 254, detection: 3 nl cell, inj.: 500 nl, sample: d(pT)₁₂₋₁₈, 5 ng total, approx. 180 fmol each oligonucleotide). In both cases the mixture is well separated, but in the case of MS/BVPE the separation is performed two minutes faster due to the possibility of applying a higher volumentric flow (7 μl/min compared to 4 μl/min). Additionally Table 1(a) summarises some important chromatographic characteristics. Peak width at half peak height (b_{0.5}) and resolution (R) prove the excellent separation performance of monolithic MS/BVPE.

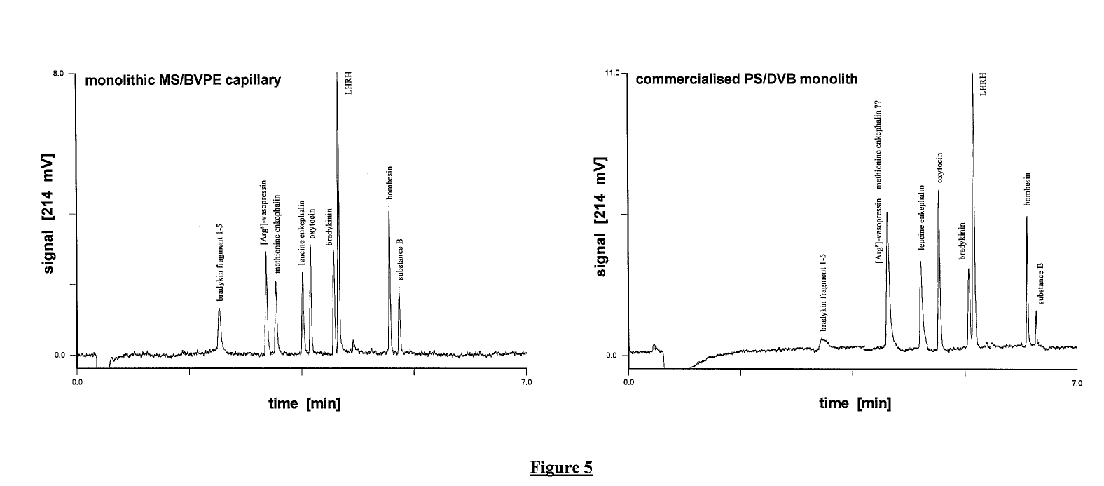

FIG. 5 presents the separation of a 9-peptide mixture—containing bradykinin fragment 1-5, vasopressin [arg⁸], methionine enkephalin, leucine enkephalin, oxytocin, bradykinin, LHRH, bombesin and substance B—using reversed phase (RP) conditions (solvent A: 0.1% TFA in H₂O, solvent B: 0.1% TFA in ACN, linear gradient: 0-30% B in 5 min, 60° C., UV 214, detection: 3 nl cell, inj.: 500 nl, sample: 9-peptide mix, 0.2 ng each peptide, approx. 200 fmol each peptide). Again, it can be seen, that the overall separation in the case of the MS/BVPE monolith is speeded up. Table 1(b) give the responding retention times and further present b_{0.5} and R values for comparison.

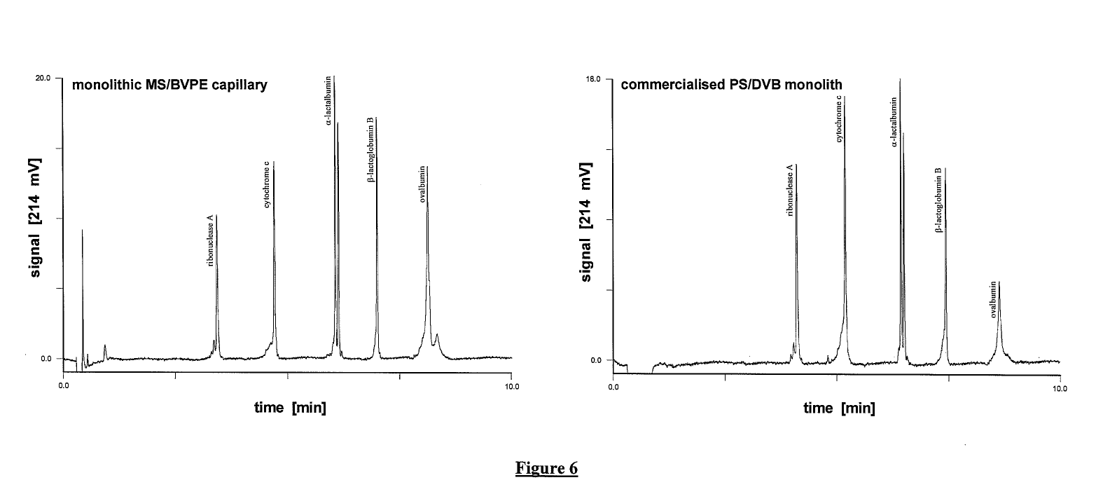

Moreover the novel monolithic MS/BVPE material proved to be appropriate for the separation of big biomolecules (proteins) with high efficiency (FIG. 6), as a 5-protein mixture, containing ribonuclease A, cyctochrome c, α-lactalbumin, , β-lactoglobulin and ovalbumin, is separated under RP conditions (solvent A: 0.1% TFA in H2O, solvent B: 0.1% TFA in ACN, linear gradient: 15-60% B in 10 min, 60° C., UV 214, detection: 3 nl cell, inj.: 500 nl, sample: 5-protein mix, approx. 4 ng each protein, approx. 300 (cytochrome c) to 100 (ovalbumin) fmol each protein) using a shallow gradient. Nevertheless peak half width is kept remarkable low (1.4 to 2.5 sec only). Further information on chromatographic parameters is given in Table 1(c).

The examples given here clearly demonstrate the advantages of monolithic MS/BVPE over other hydrophobic monolithic materials used as RP separation media. Using optimised polymerisation conditions with toluene as microporogen and decanol as macroporogen MS/BVPE monolithic capillary columns are produced, that show favourable permeability properties while they still enable high resolution separation of proteins, peptides and oligonucleotides that are comparable and even better that those performaed on commercially available monolithic materials.

### EXAMPLE 1

FIG. 1 shows a schematic reaction scheme illustrating the synthesis of BVPE as well as its copolymerisation with methylstyrene.

The crosslinker used for the fabrication of the novel monolithic MS/BVPE material can be prepared as follows: A mixture of 11.3 ml p-vinylbenzyl chloride (80 mmol) and 1.95 g magnesium (80 mmol) in 200 ml THF is gently stirred under argon at room temperature (RT) for 1.5 h. The reaction is controlled by cooling with water or stronger stirring. Afterwards the mixture is extracted with a saturated NaHCO₃ solution. The organic layer is evaporated and the yellowish crude product is purified by column chromatography using a mixture of petroleum ether and diethyl ether (95:5). Yield: 7.6 g (81% of theory), sparkling white crystals. The purity of the product BVPE is proved by ¹H and ¹³C-NMR as well as liquid chromatography.

A preferred embodiment of the monolithic polymer according to the invention can be prepared by thermally initiated free radical polymerisation of methylstyrene (MS) and 1,2-bis(p-vinylphenyl)ethane (BVPE). α,α′-azoisobutyronitrile (AIBN) is used as initiator. The polymerisation is performed in the presence of an inert diluent (porogen) at 65° C. in a water bath under gentle shaking. A high yield synthesis of BVPE was indroduced by Li. et al. [19], using a Grignard dimerisation of commercially available p-vinylbenzyl chloride.

### EXAMPLE 2

Fused silica capillary (200 μm I.D.) are silanised by etching the inner wall surface with NaOH, followed by reaction with 3-(trimethoxysilyl)propyl acrylate in the presence of 2,2-diphenyl-1-picryl-hydrazyl (DPPH) [23]. 5 mg AIBN and 87.3 mg BVPE are weighed out into a glass vial. 97.5 μl MS, 260.0 μl decanol and 45.0 μl toluene are added, the vial sealed and the mixture dissolved in a sonication bath at 65° C. until a clear solution is reached. This solution is filled in a preheated, silanised fused silica capillary, using a warmed syringe. The polymerisation is allowed to proceed at 65° C. for 24 h in a water bath under gentle shaking.

After polymerisation the capillary-monolith is purged with acetonitrile for 1 h to remove all of the porogen and non reacted monomers using an air pressure driven pump and finally cut to 8 cm. The capillary is connected to a HPLC pump; for flow-splitting, a T-piece is installed between the pump and the monolith. The pump is then subsequently driven with four different solvents (water, tetrahydrofuran, methanol and acetonitrile) and the relationship between column backpressure and resulting flow-rate is monitored at room temperature. The results are shown in FIG. 2.

As it can be seen in FIG. 2, the measuring points show high linearity (R²>0.9997 for all cases), which indicates high mechanical stability of the monolithic rod. Furthermore it can be seen, that the solvents cause column backpressure according their dynamic viscosity (Darcy's law), except tetrahydrofuran, which cause slight polymer swelling. Nevertheless the swelling in tetrahydrofuran is low, as the swelling propensity (SP) factor [17] is generally found to be lower than 0.7, employing a molar MS to BVPE ratio of 2:1 only.

### EXAMPLE 3

5 mg AIBN and 78.3 mg BVPE are weighed out into a glass vial. 87.5 μl MS, 255.0 μl decanol and 70.0 μl toluene are added, the vial sealed and the mixture dissolved in a sonication bath at 65° C. until a clear solution is reached. This solution is filled in a preheated, silanised fused silica capillary (200 μl I.D.), using a warmed syringe. The polymerisation is allowed to proceed at 65° C. for 24 h in a water bath under gentle shaking.

After polymerisation the capillary-monolith is purged with acetonitrile for 1 h to remove all porogen and non reacted monomers using an air pressure driven pump and finally cut to 8 cm. The capillary is connected to a HPLC pump; for flow-splitting, a T-piece is installed between the pump and the monolith. The pump is subsequently driven with water and acetonitrile and the relationship between column backpressure and resulting flow-rate is monitored at room temperature. This relationship is further determined for a commercially available PS/DVB monolith (Dionex) (50×0.2 mm) after attaching it to the same pump. When comparing the results, it is found, that the commercially available PS/DVB monolith is restricted to the application of a volumetric flow-rate of approximately 4 μl/min, using 100% water as solvent, whereas the MS/BVPE monolith enables the application of a flow-rate 2.5 fold higher reaching the same backpressure (FIG. 3). Taking into account, that the column length of the novel MS/BVPE monolith is raised by 60% (5.0 to 8.0 cm), the column permeability is exceptionally high. This enables strong reduction in column equilibration times between gradient runs and moreover allows the application of steep gradients to achieve fast separations.

### EXAMPLE 4

5 mg AIBN and 78.3 mg BVPE are weighed out into a glass vial. 87.5 μl MS, 255 μl decanol and 70 μl toluene are added, the vial sealed and the mixture dissolved in a sonication bath at 65° C. until a clear solution is reached. This solution is filled in a preheated, silanised fused silica capillary (200 μl I.D.), using a warmed syringe. The polymerisation is allowed to proceed at 65° C. for 24 h in a water bath under gentle shaking.

After polymerisation the capillary-monolith is purged with acetonitrile for 1 h to remove all porogen and non reacted monomers using an air pressure driven pump and finally cut to 8 cm. The capillary monolith is attached to a micro-LC system, that consists of a micro pump, a degasser, a 6-way injection valve and a 3 nl Z-cell UV detector. A T-piece placed between pump and injection valve is used for flow-splitting. Injection volume is 500 nl and implemented by using a fused silica capillary (75 μm I.D.).

An oligodeoxynucleotide standard [d(pT)₁₂₋₁₈] is then separated on the MS/BVPE column using IP-RP conditions: solvent A: 0.1 M TEAA, pH 7, solvent B: 0.1 M TEAA in 40% acetonitrile, pH 7, 2-step gradient: 0-20% B in 1 min and 20-40% B in 7 min, 50° C., Uv 254, detection: 3 nl cell, inj.: 500 nl, sample: d(pT)₁₂₋₁₈, 5 ng total, approx. 180 fmol each oligonucleotide. The separation is performed at a flow-rate of 7 μl/min. Afterwards, a commercially available PS/DVB monolith (Dionex) (50×0.2 μm) is attached to the same micro-LC system. An oligonucleotide standard [d(pT)₁₂₋₁₈] is then separated on the PS/DVB column using the same conditions as mentioned above. Due to the restricted permeability of this monolith, the separation is performed at 4 μl/min.

FIG. 4 presents the comparison of the two chromatograms obtained. In both cases the mixture is well separated, but in the case of MS/BVPE the separation is performed two minutes faster due to the possibility of applying a higher volumentric flow. Additionally Table 1(a) summarises some important chromatographic characteristics. Peak width at half peak height (b_{0.5}) and resolution (R) prove the excellent separation performance of monolithic MS/BVPE.

### EXAMPLE 5

5 mg AIBN and 78.3 mg BVPE are weighed out into a glass vial. 87.5 μl MS, 255 μl decanol and 70 μl toluene are added, the vial sealed and the mixture dissolved in a sonication bath at 65° C. until a clear solution is reached. This solution is filled in a preheated, silanised fused silica capillary (200 μl I.D.), using a warmed syringe. The polymerisation is allowed to proceed at 65° C. for 24 h in a water bath under gentle shaking.

After polymerisation, the capillary-monolith is purged with acetonitrile for 1 h to remove all porogen and non reacted monomers using an air pressure driven pump and finally cut to 8 cm. The capillary monolith is attached to a micro-LC system, that consists of a micro pump, a degasser, a 6-way injection valve and a 3 nl Z-cell UV detector. A T-piece placed between pump and injection valve is used for flow-splitting. Injection volume is 500 nl and implemented by using a fused silica capillary (75 μm I.D.).

A peptide standard mixture—containing bradykinin fragment 1-5, vasopressin [arg⁸], methionine enkephalin, leucine enkephalin, oxytocin, bradykinin, LHRH, bombesin and substance B—is separated using reversed phase (RP) conditions: solvent A: 0.1% TFA in H₂O, solvent B: 0.1% TFA in acetonitrile, linear gradient: 0-30% B in 5 min, 60° C., UV 214, detection: 3 nl cell, inj.: 500 nl, sample: 9-peptide mix, 0.2 ng each peptide, approx. 200 fmol each peptide. The separation is performed at 8 μl/min. The PS/DVB monolith obtained from Dionex is then attached to the same micro-LC device and the peptide separation again performed under the same chromatographic conditions listed above. Due to the restricted permeability of this monolith, the separation is performed at 4 μl/min. These separations are demonstrated in FIG. 5 for comparison. Again, it can be seen, that the overall separation in the case of the MS/BVPE monolith is speeded up (see Table 1(b) for the responding retention times). Table 1(b) further presents b_{0.5} and R values, which show that the MS/BVPE capillary give similar or even better results that the commercial available PS/DVB.

### EXAMPLE 6

5 mg AIBN and 78.3 mg BVPE are weighed out into a glass vial. 87.5 μl MS, 255 μl decanol and 70 μl toluene are added, the vial sealed and the mixture dissolved in a sonication bath at 65° C. until a clear solution is reached. This solution is filled in a preheated, silanised fused silica capillary (200 μl I.D.), using a warmed syringe. The polymerisation is allowed to proceed at 65° C. for 24 h in a water bath under gentle shaking.

After polymerisation the capillary-monolith is purged with acetonitrile for 1 h to remove all porogen and non reacted monomers using an air pressure driven pump and finally cut to 8 cm. The capillary monolith is attached to a micro-LC system, that consists of a micro pump, a degasser, a 6-way injection valve and a 3 nl Z-cell UV detector. A T-piece placed between pump and injection valve is used for flow-splitting. Injection volume is 500 nl and implemented by using a fused silica capillary (75 μm I.D.).

A 5-protein mixture—containing ribonuclease A, cyctochrome c, α-lactalbumin, β-lactoglobulin and ovalbumin—is separated under RP conditions using a shallow gradient: solvent A: 0.1% TFA in H₂O, solvent B: 0.1% TFA in acetonitrile, linear gradient: 15-60% B in 10 min, 60° C., UV 214, detection: 3 nl cell, inj.: 500 nl, sample: 5-protein mix, approx. 4 ng each protein, approx. 300 (cytochrome c) to 100 (ovalbumin) fmol each protein. The separation is performed at 8 μl/min. The commercially available PS/DVB monolith (50×0.2 mm) obtained from Dionex is then attached to the same micro-LC device and the protein separation performed under the same chromatographic conditions mentioned above. Due to the restricted permeability of this monolith, the separation is performed at 4 μl/min. FIG. 6 demonstrates that the MS/BVPE monolith is appropriate for the separation of big biomolecules (proteins) with high efficiency. Furthermore it can be derived from FIG. 6 that MS/BVPE offer similar results that the commercial monolith. Although applying a shallow gradient, peak width at half peak height (b_{0.5}) is still kept remarkable low (1.4 to 2.5 sec only). Further chromatographic details are summarised in Table 1(c).

TABLE 1

| | MS/BVPE | | | PS/DVB | | |
|---|---|---|---|---|---|---|
| analyte | t_{R} [min] | b_{0.5} [sec] | R | t_{R} [min] | b_{0.5} [sec] | R |

(a)
Oligonucleotides

| | | | | | | |
|---|---|---|---|---|---|---|
| dT₁₂ | 3,873 | 2,400 | 2,433 | 5,523 | 2,800 | 2,202 |
| dT₁₃ | 4,040 | 2,200 | 2,391 | 5,707 | 2,800 | 2,139 |
| dT₁₄ | 4,197 | 2,200 | 2,132 | 5,873 | 2,400 | 2,094 |
| dT₁₅ | 4,337 | 2,200 | 1,919 | 6,023 | 2,400 | 1,913 |
| dT₁₆ | 4,463 | 2,200 | 1,782 | 6,160 | 2,400 | 1,773 |
| dT₁₇ | 4,580 | 2,200 | 1,707 | 6,287 | 2,400 | 1,620 |
| dT₁₈ | 4,687 | 2,000 | — | 6,403 | 2,400 | — |

(b)
Peptides

| | | | | | | |
|---|---|---|---|---|---|---|
| bradikinin fragment 1-5 | 2,157 | 3,200 | 9,322 | 2,993 | — | — |
| [Arg⁸]-vasopressin | 2,880 | 1,998 | 2,464 | 4,010 | 3,200 | 5,589 |
| methionine enkephalin | 3,027 | 2,000 | 6,870 | | | |
| leucine enkephalin | 3,437 | 2,000 | 2,234 | 4,527 | 3,000 | 3,753 |
| oxytocin | 3,557 | 1,600 | 6,226 | 4,807 | 2,000 | 7,707 |
| bradykinin | 3,910 | 2,200 | 1,223 | 5,267 | 2,000 | 1,235 |
| LHRH | 3,983 | 1,800 | 15,257 | 5,337 | 1,800 | 16,420 |
| bombesin | 4,757 | 1,600 | 2,878 | 6,170 | 1,600 | 2,932 |
| substance B | 4,903 | 1,800 | — | 6,310 | 1,600 | — |

(c)
Proteins

| | | | | | | |
|---|---|---|---|---|---|---|
| ribonuclease A | 3,400 | 2,100 | 22,575 | 4,155 | 2,000 | 19,224 |
| cytochrome c | 4,680 | 1,700 | 28,274 | 5,245 | 1,800 | 26,706 |
| α-lactalbumin | 6,030 | 1,500 | 1,733 | 6,560 | 1,500 | 1,618 |
| | 6,105 | 1,400 | 18,944 | 6,630 | 1,400 | 12,108 |
| β-lactoglobulin B | 6,953 | 1,600 | 19,043 | 7,172 | 1,600 | 22,534 |
| ovalbumin | 8,118 | 2,500 | — | 8,685 | 2,900 | — |

### REFERENCES

[1] E. C. Peters, F. Svec, J. M. J. Fréchet, Adv. Mater., 11 (1999) 1169-1181.
[2] H. Zou, X. Huang, M. Ye, Q. Luo, J. Chromatogr. A, 954 (2002) 5-32.
[3] F. Svec, J. Sep. Sci, 27 (2004) 747-766.
[4] H. Oberacher, A. Premstaller, C. G. Huber, J. Chromatogr. A, 1030 (2004) 201-208.
[5] O. Okay, Prog. Polym. Sci., 25 (2000) 711-779.
[6] J. Grafnetter, P. Coufal, E. Tesa\check{r}ová, J. Suchánková, Z. Bosáková, J. \check{S}ev\check{c}ik, J. Chromatogr. A, 1049 (2004) 43-49.
[7] Q. C. Wang, F. Svec, J. M. J. Fréchet, Anal. Chem., 65 (1993) 2243-2248.
[8] M. Petro, F. Svec, J. M. J. Fréchet, J. Chromatogr. A, 752 (1996) 59-66.
[9] A. Premstaller, H. Oberacher, C. G. Huber, Anal. Chem., 72 (2000) 4386-4393.
[10] M. Merhar, A. Podgornik, M. Barut, M. Zigon, A. Strancar, J. Sep. Sci., 26 (2003) 322-330.
[11] F. Svec, J. Sep. Sci., 27 (2004) 747-766.
[12] D. Lee, F. Svec, J. M. J. Fréchet, J. Chromatogr. A, 1051 (2004) 53-60.
[13] F. Sinner, M. R. Buchmeiser, Macromolecules, 33 (2000) 5777-5786.
[14] S. M. Fields Anal Chem., 68 (1996) 2709-2712.
[15] H. Minakuchi, N. Nakanishi, N. Soga, N. Ishizuka, N. Tanaka, Anal. Chem., 68 (1996) 3498-3501.
[16] A. Premstaller, H. Oberacher, W. Walcher, A. M. Timperio, L. Zolla, J. Chervet, N. Cavusoglu, A. van Dorsselaer, C. G. Huber, Anal Chem., 73 (2001) 2390-2396.
[17] F. Nevejans, M. Verzele, J Chromagr., 350 (1985) 45-150.
[18] X. Huang, S. Zhang, G. A. Schultz, J. Henion, Anal. Chem., 74 (2002) 2336-2344.
[19] W. Li, K. Li, H. D. H. Stöver, A. E. Hamielec, J. Polym. Sci. A, 32 (1994) 2023-2027.
[20] F. Svec, J. M. J. Fréchet. Chem. Mater., 7 (1995) 717-715.
[21] F. Svec, J. M. J. Fréchet, Macromolecules, 28 (1995) 7580-7582.
[22] P. Hörstedt, F. Svec, Chem. Mater., 9 (1997) 463-471.
[23] C. P. Bisjak, R. Bakry, C. W. Huck, G. K. Bonn, Chromatographia, 2005, 62, 31-36

1. Monolithic organic copolymer prepared by copolymerisation of an (C₁-C₃)alkylstyrene and a member out of the group consisting of bis(vinylphenyl)(C₁-C₄)alkane and bis(vinylphenyl(C₁-C₂)alkyl)benzene in the presence of a porogen, wherein said porogen comprises decanol and at least one of the group consisting of tetrahydrofuran and toluene.

2. Monolithic organic copolymer according to claim 1, wherein said porogen is a mixture of decanol and toluene.

3. Monolithic organic copolymer according to claim 1, wherein said porogen is a mixture of decanol and tetrahydrofuran.

4. Monolithic organic copolymer according to one of claims 1 to 3, wherein said (C₁-C₃)alkylstyrene is one of the group of mono-, di, and trimethylstyrene, in particular p-methylstyrene.

5. Monolithic organic copolymer according to claim 1, wherein said bis(vinylphenyl)(C₁-C₄)alkane is 1,2-bis(p-vinylphenyl)ethane.

6. Monolithic organic copolymer according to claim 1, wherein said copolymerisation is carried out in a mixture containing said porogen, said alkylstyrene and said divinylbenzene derivative, characterized in that said porogen, when being a mixture of decanol and tetrahydrofuran, is in the range of 60-65 vol.-%, and when being a mixture of decanol and toluene, is in the range of 59-80 vol.-%, with the rest being alkylstyrene and divinylbenzene.

7. A method for separating biopolymers using high performance liquid chromatography, characterized in that as stationary phase a monolithic organic polymer according to claim 1 is used.
